(19) United States
(12) Patent Application Publication
(10) Pub. No.: US 2014/0067141 A1
(43) Pub. Date: Mar. 6, 2014

(54) POWER CONTROL EQUIPMENT, POWER CONTROL SYSTEM, AND POWER CONTROL METHOD

(71) Applicant: KABUSHIKI KAISHA TOSHIBA, Tokyo (JP)

(72) Inventors: Toshikatsu MASUDA, Kanagawa (JP); Rempei Nakata, Kanagawa (JP); Shuji Suzuki, Kanagawa (JP)

(73) Assignee: KABUSHIKI KAISHA TOSHIBA, Tokyo (JP)

(21) Appl. No.: 13/826,928

(22) Filed: Mar. 14, 2013

(30) Foreign Application Priority Data
Aug. 29, 2012 (JP) 2012-188533

(51) Int. Cl. G06F 1/32

(52) U.S. Cl. CPC G06F 1/3206
USPC 700/291

(57) ABSTRACT

According to one embodiment, a communication interface, a power trajectory calculating unit, and an activation control unit are provided. The communication interface acquires data regarding a power value transmitted to the activated power consumption bodies. The power trajectory calculating unit calculates a trajectory of the power value transmitted to the activated power consumption bodies. The activation control unit controls an activation of an inactive power consumption body based on the trajectory of the power value.

### CROSS-REFERENCE TO RELATED APPLICATIONS

This application is based upon and claims the benefit of priority from Japanese Patent Application No. 2012-188533, filed on Aug. 29, 2012; the entire contents of which are incorporated herein by reference.

### FIELD

Embodiments described herein relate generally to power control equipment, a power control system, and a power control method.

### BACKGROUND

In a power system that supplies power to a plurality of power consumption bodies, it is necessary to set power facility so as to accommodate the peak of the consumption power of the power consumption bodies. Therefore, the size of the power facility increases compared to the average consumption power of the power consumption bodies.

### BRIEF DESCRIPTION OF THE DRAWINGS

FIG. 1 is a block diagram illustrating the overall configuration of a power control system according to a first embodiment;

FIG. 2A is a diagram illustrating a method of activating a power consumption body when a power trajectory tends to increase;

FIG. 2B is a diagram illustrating a method of activating a power consumption body when the power trajectory does not tend to increase;

FIG. 3 is a flowchart illustrating the method of activating the power consumption body in the power control system according to the first embodiment;

FIG. 4 is a block diagram illustrating the overall configuration of a power control system according to a second embodiment;

FIG. 5 is a block diagram illustrating the overall configuration of a power control system according to a third embodiment;

FIG. 6 is a block diagram illustrating the overall configuration of a power control system according to a fourth embodiment; and

FIG. 7 is a flowchart illustrating a method of activating power generators of the power control system according to the fourth embodiment.

### DETAILED DESCRIPTION

In general, according to one embodiment, a communication interface, a power trajectory calculating unit, and an activation control unit are provided. The communication interface acquires data regarding a power value transmitted to an activated power consumption body. The power trajectory calculating unit calculates a trajectory of the power value transmitted to the activated power consumption body. The activation control unit controls activation from standby state of a power consumption body based on the trajectory of the power value.

Hereinafter, a power control system according to the embodiments will be described in detail with reference to the appended drawings. The invention is not limited to the embodiments.

### First Embodiment

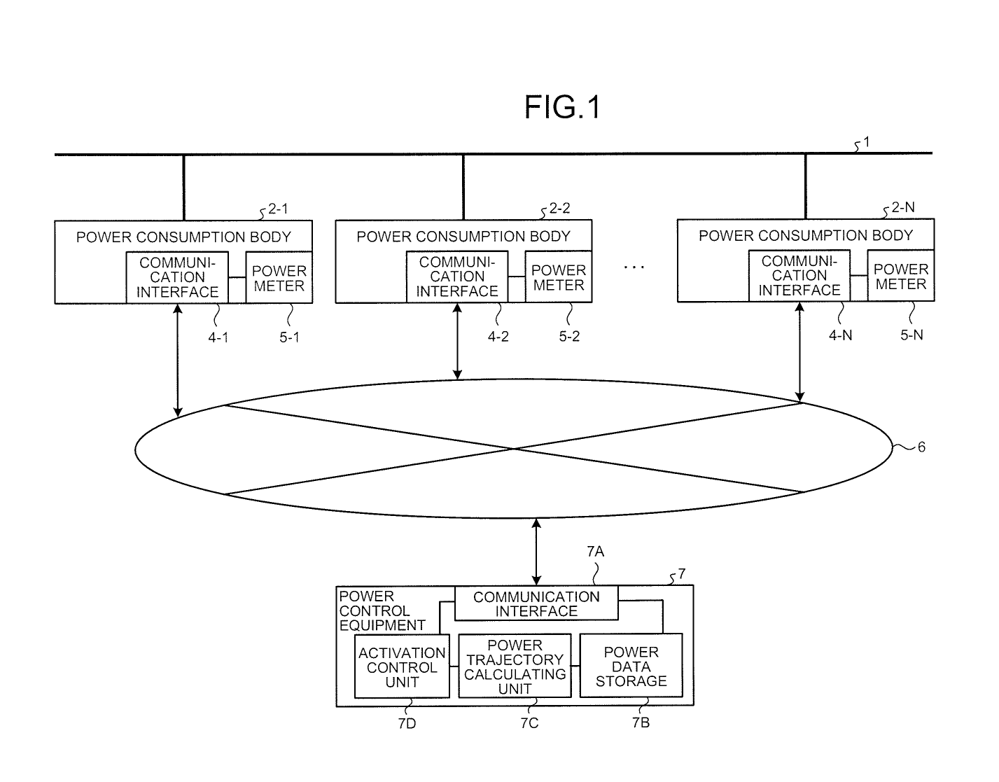

FIG. 1 is a block diagram illustrating the overall configuration of a power control system according to a first embodiment.

In FIG. 1, a plurality of power consumption bodies 2-1 to 2-N (here, N is an integer equal to or more than 2) are connected to a power system 1. The power consumption bodies 2-1 to 2-N are connected to power control equipment 7 via a communication network 6. The power consumption bodies 2-1 to 2-N are processing tools or facilities to which power is transmitted from the power system 1. The power consumption bodies 2-1 to 2-N may be, for example, semiconductor processing tools such as lithography tools or annealing tools, or CVD tools, may be air conditioning appliances such as air conditioners, or may be storage batteries. Further, the power consumption bodies 2-1 to 2-N may be distillation facilities or cracking facilities used in a petrochemical plant or may be electrolysis furnaces, electric furnaces, plating furnaces, or the like used for refining. The communication network 6 may be, for example, a LAN, may be the Internet, or may be a wireless communication network of cellular phones or the like.

Here, the power consumption bodies 2-1 to 2-N include communication interfaces 4-1 to 4-N and power meters 5-1 to 5-N, respectively. The communication interfaces 4-1 to 4-N can transmit and receive data to and from the power control equipment 7 via the communication network 6. The power meters 5-1 to 5-N can measure power values of the power consumption bodies 2-1 to 2-N, respectively. The power values indicate consumed powers (real powers) or apparent powers of the power consumption bodies 2-1 to 2-N. The apparent power may be calculated through vector synthesis of the real power and reactive power, or a value obtained from the division of the real power by the power factor may be used as the apparent power.

The power control equipment 7 includes a communication interface 7A, a power data storage 7B, a power trajectory calculating unit 7C, and an activation control unit 7D. The communication interface 7A can transmit and receive data to and from the power consumption bodies 2-1 to 2-N via the communication network 6. The power data storage 7B can chronologically record the power values to be transmitted to the power consumption bodies 2-1 to 2-N. The power trajectory calculating unit 7C can calculate the trajectories of the power values transmitted to the power consumption bodies 2-1 to 2-N. The activation control unit 7D can control the activation of the inactive power consumption bodies among 2-1 to 2-N based on the trajectories of the power values transmitted to the other, activated power consumption bodies among 2-1 to 2-N. Here, the activation control unit 7D makes the power consumption body in standby among 2-1 to 2-N having an activation request remain standby, when the trajectory of the sum of the power values of the other, activated power consumption bodies among 2-1 to 2-N tends to increase. The activation control unit 7D can permit the activation of the inactive power consumption bodies among 2-1 to 2-N having the activation request, when the trajectory of the sum of the power values of the other, activated power consumption bodies 2-1 to 2-N does not tend to increase.

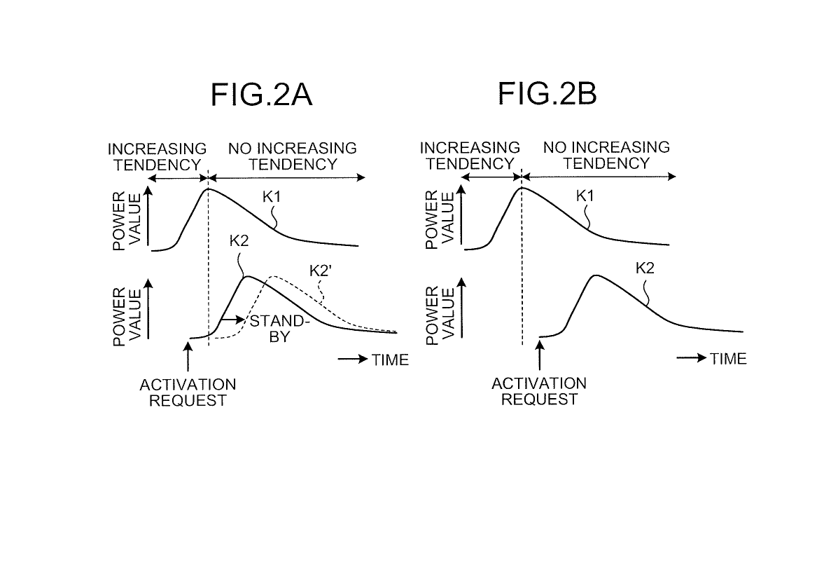

FIG. 2A is a diagram illustrating a method of activating the power consumption body, when a power trajectory tends to increase at the time of an activation request. FIG. 2B is a diagram illustrating a method of activating the power consumption body, when the power trajectory does not tend to increase. In FIGS. 2A and 2B, a case in which N is 2 is exemplified.

In FIG. 2A, for example, the power consumption body 2-1 is assumed to be activated among the power consumption bodies 2-1 to 2-N. At this time, a power value of the power consumption body 2-1 is measured by the power meter 5-1 and is transmitted to the power control equipment 7 via the communication network 6. Then, the power value of the power consumption body 2-1 is chronologically recorded on the power data storage 7B.

When an activation request of the power consumption body 2-2 is given, the activation request can be received by the power control equipment 7. Then, the power trajectory calculating unit 7C calculates a trajectory K1 of the power value of the power consumption body 2-1. Then, the activation control unit 7D determines whether the trajectory of the power value of the power consumption body 2-1 tends to increase, at the time the activation request of the power consumption body 2-2 is given. When the trajectory of the power value of the power consumption body 2-1 tends to increase, the power consumption body 2-2 remains standby. Then, the activation control unit 7D redetermines whether the trajectory of the power value of the power consumption body 2-1 tends to increase after the predetermined time. When the trajectory of the power value of the power consumption body 2-1 does not tend to increase, the activation of the power consumption body 2-2 is permitted.

Here, when the power consumption body 2-2 is activated at the time the activation request of the power consumption body 2-2 is given, the trajectory of the power value of the power consumption body 2-2 is K2. Therefore, the sum of the power values of the power consumption bodies 2-1 and 2-2 shows high peak. On the other hand, when the power consumption body 2-2 is activated after the predetermined time, the trajectory of the power value of the power consumption body 2-2 is K2′. Therefore, the load on the power system 1 can be reduced, since the peak of the sum of the power values of the power consumption bodies 2-1 and 2-2 can be lowered, compared to the case in which the power consumption body 2-2 is activated at the time the activation request of the power consumption body 2-2 is given.

On the other hand, in FIG. 2B, when the trajectory of the power value of the power consumption body 2-1 does not tend to increase at the time the activation request of the power consumption body 2-2 is given, the activation of the power consumption body 2-2 is permitted without standby. Therefore, when the trajectory of the power value of the power consumption body 2-1 does not tend to increase, the operating rate of the power consumption body 2-2 can be improved due to the prompt activation of the power consumption body 2-2. Further, when the trajectory of the power value of the power consumption body 2-1 does not tend to increase, it is possible to prevent the peaks of the power values of the power consumption bodies 2-1 and 2-2 from overlapping each other in spite of the activation of the power consumption body 2-2. Accordingly, the load on the power system 1 can be reduced.

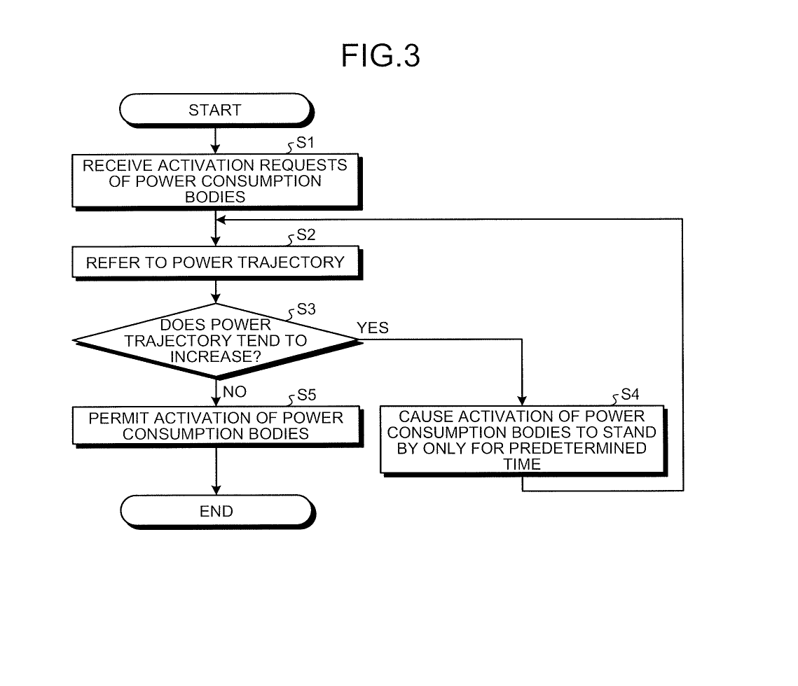

FIG. 3 is a flowchart illustrating a method of activating the power consumption bodies in the power control system according to the first embodiment.

In FIG. 3, when the activation request of the inactive power consumption bodies among 2-1 to 2-N is received by the power control equipment 7 (S1), the trajectory of the sum of the power values of the other, activated power consumption bodies among 2-1 to 2-N is referred to (S2). When the trajectory of the sum of the power values of the already activated power consumption bodies among 2-1 to 2-N tends to increase (S3), the activation of the power consumption body having the activation request remains standby for a predetermined time (S4). Then, it is redetermined whether the trajectory of the sum of the power values of the already activated power consumption bodies among 2-1 to 2-N tends to increase, after the predetermined time. When the trajectory of the sum of the power values of the already activated power consumption bodies among 2-1 to 2-N does not tend to increase, the activation of the power consumption body among 2-1 to 2-N having the activation request is permitted (S5).

A period traced back to the past from the time at the activation request by a certain time can be set as a referring range of the trajectory of the sum of the power values of the already activated power consumption bodies among 2-1 to 2-N. When the power consumption bodies among 2-1 to 2-N became standby after the previous activation request, a period traced back to the past by a certain time from the time at the next activation request. The certain time can be individually set by each of the power consumption bodies 2-1 to 2-N. For example, when the power consumption bodies 2-1 to 2-N are semiconductor processing tools, about 10 to 15 minutes can be set. Alternatively, the certain time can be set at the period of one cycle time from the operation start to the termination, or can be set at the maximum time in which the sum of the power value of the power consumption bodies 2-1 to 2-N becomes a half or more than the average of the sum of the power value during a day. For example, in the case that the average power value of one day is 600 kW, when the sum of the power values of the power consumption bodies 2-1 to 2-N indicates 300 kW or more at “6:00 AM to 8:00 AM” and “1:00 PM to 5:00 PM” in one day, the maximum time of four hours “1:00 PM to 5:00 PM” can be set as the certain time.

The interval of which the trajectory of the sum of the power values of the already activated power consumption bodies among 2-1 to 2-N is referred to again after the standby of the power consumption bodies among 2-1 to 2-N having the activation request can be set to, for example, a shorter time between one minute and 1/10 of the referring range of the trajectory of the sum of the power values of the already activated power consumption bodies among 2-1 to 2-N.

The tendency to increase the trajectory of the sum of the power values of the already activated power consumption bodies among 2-1 to 2-N may be a monotonous increasing case or may be an increasing case of the average value or the median value, even when the trajectory of the sum of the power values of the already activated power consumption bodies among 2-1 to 2-N fluctuates upward and downward.

In the above-described embodiment on FIGS. 2A and 2B, the method of causing the power consumption body 2-2 to remain standby has been described when the trajectory of the power value of the power consumption body 2-1 tends to increase. However, only when the trajectory of the power value of the power consumption body 2-1 tends to increase and the power value of the power consumption body 2-1 is equal to or more than a set value, the power consumption body 2-2 may remain standby. At this time, even when the trajectory of the power value of the power consumption body 2-1 tends to increase but the power value of the power consumption body 2-1 is less than the set value, the activation of the power consumption body 2-2 can be immediately permitted.

### Second Embodiment

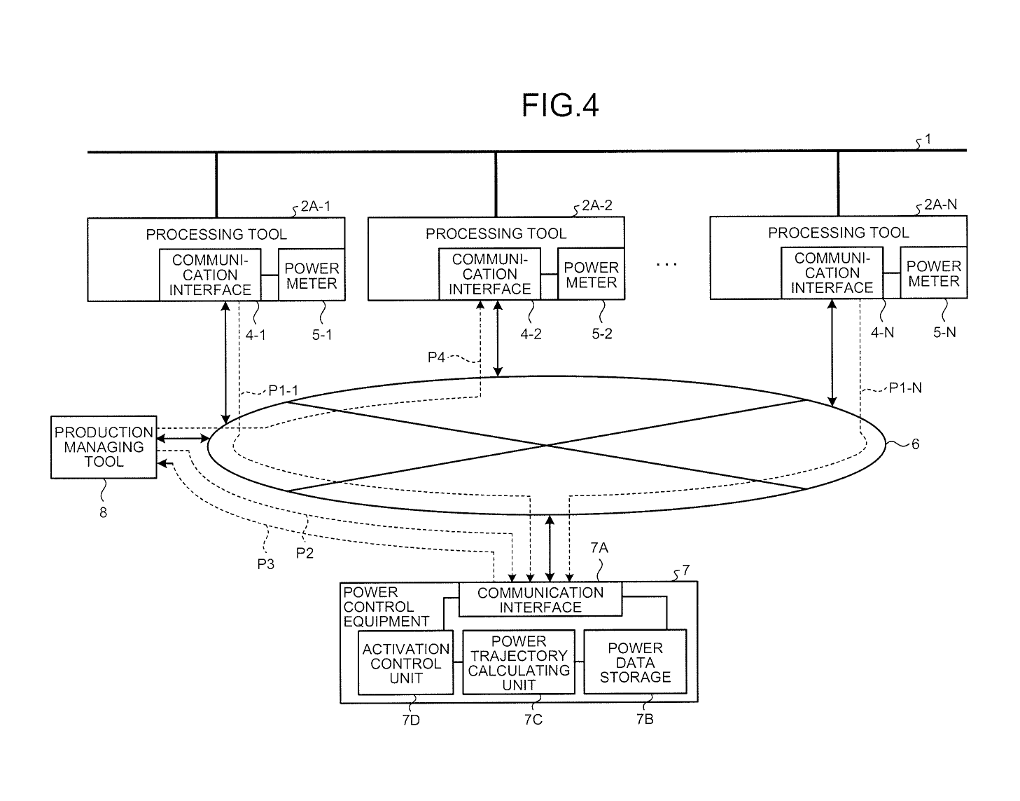

FIG. 4 is a block diagram illustrating the overall configuration of a power control system according to a second embodiment.

In FIG. 4, the power control system includes processing tools 2A-1 to 2A-N as the power consumption bodies 2-1 to 2-N illustrated in FIG. 1. The processing tools 2A-1 to 2A-N may be semiconductor manufacturing tools, may be distillation facilities or cracking facilities used in a petrochemical plant, or may be electrolysis furnaces, electric furnaces, plating furnaces, or the like used for refining. Further, the processing tools 2A-1 to 2A-N may be, for example, food processing tools that stir, cut, and heat food ingredients or automobile production tools that perform welding, transporting, and pressing.

A production managing tool 8 is connected to a communication network 6. The production managing tool 8 can give an instruction to activate the processing tools 2A-1 to 2A-N in a predetermined process order via the communication network 6. The production managing tool 8 can manage the activation states of the processing tools 2A-1 to 2A-N or the progress status of a manufacturing process in accordance with each product or each lot.

The processing tools 2A-1 and 2A-3 to 2A-N are assumed to be activated among the processing tools 2A-1 to 2A-N. At this time, the power values of the processing tools 2A-1 and 2A-3 to 2A-N are respectively measured by power meters 5-1 and 5-3 to 5-N and are transmitted to a power control equipment 7 via the communication network 6 (P1-1 to P1-N). Then, the sum of the power values of the processing tools 2A-1 and 2A-3 to 2A-N is chronologically recorded on power data storage 7B.

When the production managing tool 8 gives an instruction to activate the processing tool 2A-2, an activation request of the processing tool 2A-2 is previously given to the power control equipment 7 (P2). Then, when the activation request of the processing tool 2A-2 is given, the power control equipment 7 can receive the activation request. Then, a power trajectory calculating unit 7C calculates a trajectory of the sum of the power values of the processing tools 2A-1 and 2A-3 to 2A-N. Then, an activation control unit 7D determines whether the trajectory of the sum of the power values of the processing tools 2A-1 and 2A-3 to 2A-N tends to increase, when the activation request of the processing tool 2A-2 is given. When the trajectory of the sum of the power values of the processing tools 2A-1 and 2A-3 to 2A-N tends to increase, the activation of the processing tool 2A-2 remains standby. Then, after a predetermined time, the activation control unit 7D redetermines whether the trajectory of the sum of the power values of the processing tools 2A-1 and 2A-3 to 2A-N tends to increase. When the trajectory of the sum of the power values of the processing tools 2A-1 and 2A-3 to 2A-N does not tend to increase, the activation of the processing tool 2A-2 is permitted and the fact that the activation of the processing tool 2A-2 is permitted can be delivered to the production managing tool 8 (P3). Then, the production managing tool 8 gives an instruction to activate the processing tool 2A-2 (P4), and the processing tool 2A-2 is activated.

### Third Embodiment

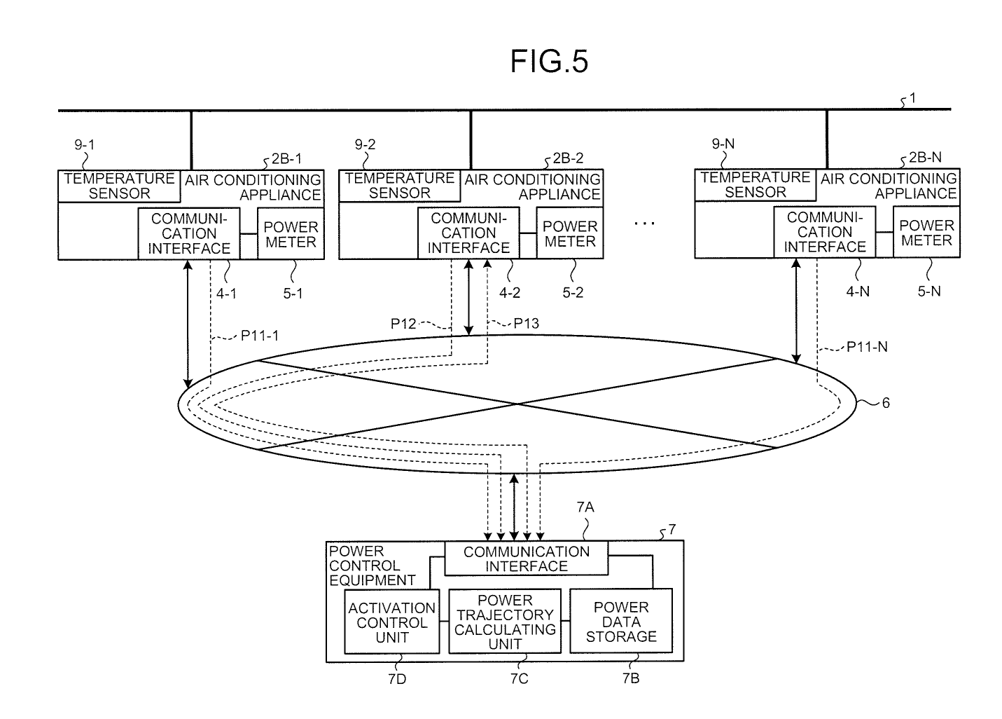

FIG. 5 is a block diagram illustrating the overall configuration of a power control system according to a third embodiment.

In FIG. 5, the power control system includes air conditioning appliances 2B-1 to 2B-N as the power consumption bodies 2-1 to 2-N illustrated in FIG. 1. For example, the air conditioning appliances 2B-1 to 2B-N can perform indoor cooling and heating. The air conditioning appliances 2B-1 to 2B-N includes temperature sensors 9-1 to 9-N, respectively. The temperature sensors 9-1 to 9-N can measure the ambient temperature of the surroundings around the air conditioning appliances 2B-1 to 2B-N.

The air conditioning appliances 2B-1 and 2B-3 to 2B-N are assumed to be activated among the air conditioning appliances 2B-1 to 2B-N. At this time, the power values of the air conditioning appliances 2B-1 and 2B-3 to 2B-N are measured by power meters 5-1 and 5-3 to 5-N, respectively, and are transmitted to a power control equipment 7 via a communication network 6 (P11-1 to P11-N). Then, the sum of the power values of the air conditioning appliances 2B-1 and 2B-3 to 2B-N is chronologically recorded on power data storage 7B.

The ambient temperature of the surroundings around the air conditioning appliance 2B-2 is measured through the temperature sensor 9-2. When the ambient temperature of the surroundings around the air conditioning appliance 2B-2 is equal to or more than a set value in cooling operation, an activation request of the air conditioning appliance 2B-2 is given to the power control equipment 7 via the communication network 6 (P12). When the activation request of the air conditioning appliance 2B-2 is given, the power control equipment 7 receives the activation request. Then, a power trajectory calculating unit 7C calculates a trajectory of the sum of the power values of the air conditioning appliances 2B-1 and 2B-3 to 2B-N. Then, an activation control unit 7D determines whether the trajectory of the sum of the power values of the air conditioning appliances 2B-1 and 2B-3 to 2B-N tends to increase, when the activation request of the air conditioning appliance 2B-2 is given. When the trajectory of the sum of the power values of the air conditioning appliances 2B-1 and 2B-3 to 2B-N tends to increase, the air conditioning appliance 2B-2 remains standby. Then, after a predetermined time, the activation control unit 7D redetermines whether the trajectory of the sum of the power values of the air conditioning appliances 2B-1 and 2B-3 to 2B-N tends to increase. When the trajectory of the sum of the power values of the air conditioning appliances 2B-1 and 2B-3 to 2B-N does not tend to increase, the activation of the air conditioning appliance 2B-2 is permitted (P13).

### Fourth Embodiment

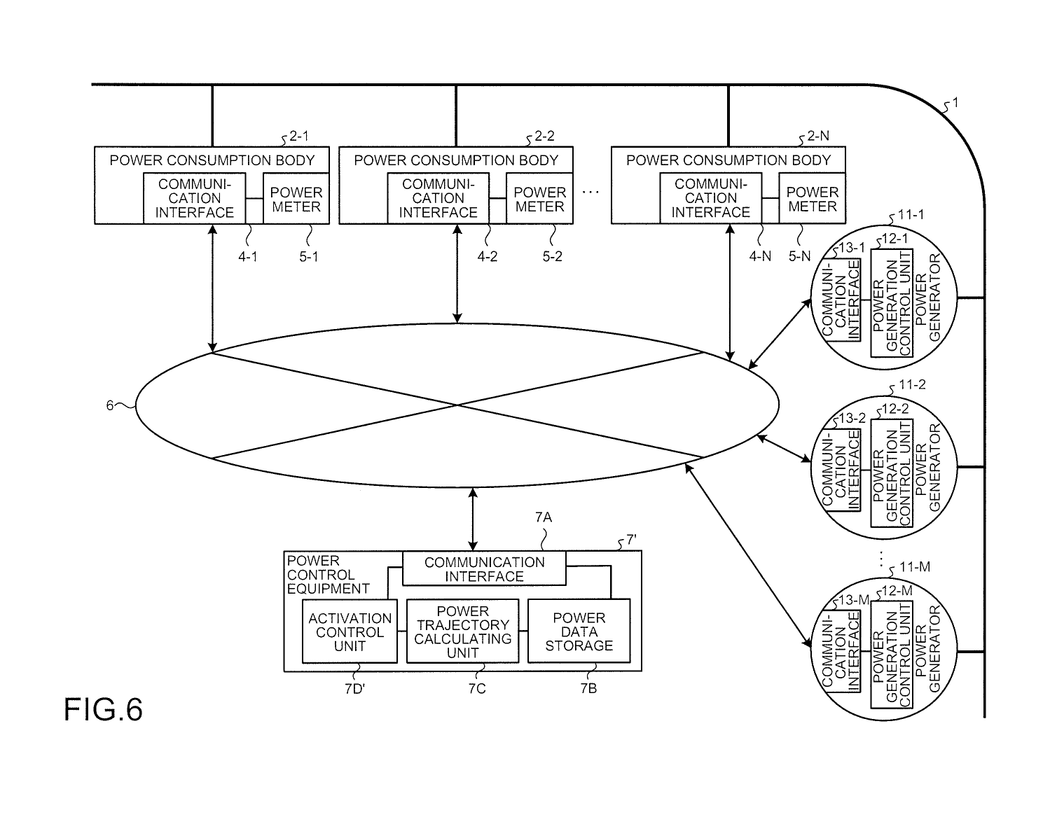

FIG. 6 is a block diagram illustrating the overall configuration of a power control system according to a fourth embodiment.

In FIG. 6, the power control system further includes power generators 11-1 to 11-M (where M is a positive integer) in addition to the power control system illustrated in FIG. 1. The power control equipment 7′ is installed instead of the power control equipment 7 illustrated in FIG. 1. The power control equipment 7′ includes an activation control unit 7D′ instead of the activation control unit 7D. The activation control unit 7D′ can control the activation of the power generators 11-1 to 11-M based on the trajectories of the power values transmitted to the activated power consumption bodies 2-1 to 2-N. The power generators 11-1 to 11-M are connected to the power system 1 and are also connected to the power control equipment 7′ via a communication network 6.

Here, the power generators 11-1 to 11-M include power generation control units 12-1 to 12-M and communication interfaces 13-1 to 13-M, respectively. The power generation control units 12-1 to 12-M can turn on/off the power generators 11-1 to 11-M or control outputs of the power generators 11-1 to 11-M, respectively. The communication interfaces 13-1 to 13-M can transmit and receive data to and from the power control equipment 7 via the communication network 6.

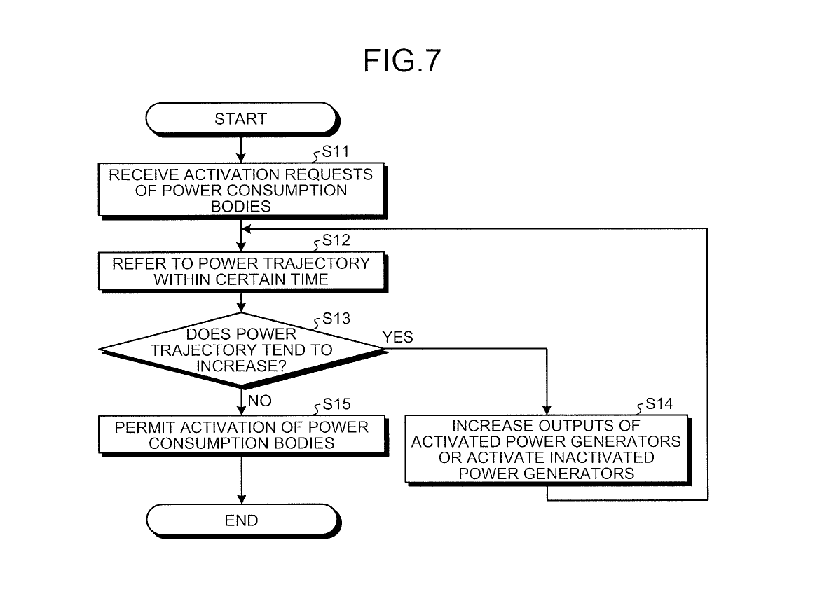

FIG. 7 is a flowchart illustrating a method of activating the power generators of the power control system according to the fourth embodiment.

In FIG. 7, when the power control equipment 7′ receives activation requests from one of the power consumption bodies in standby among 2-1 to 2-N (S11), the trajectory of the sum of the power values of the other, activated power consumption bodies among 2-1 to 2-N is referred to (S12). When the trajectory of the sum of the power values of the already activated power consumption bodies among 2-1 to 2-N tends to increase (S13), a few power generators in standby among 11-1 to 11-M are activated (S14). Alternatively, the outputs of the activated power generators among 11-1 to 11-M may be increased. Thereafter, it is redetermined whether the trajectory of the sum of the power values of the already activated power consumption bodies among 2-1 to 2-N tends to increase, even after subtracting, from the sum, the outputs of the activated power generators among 11-1 to 11-M. When the trajectory of the sum minus the generator outputs does not tend to increase, the activation of the power consumption body among 2-1 to 2-N having the activation request is permitted (S15).

In this case, when the trajectory of the sum of the power values of the power consumption bodies among 2-1 to 2-N tends to increase, the power consumption body among 2-1 to 2-N having the activation request can be activated without standby by activating a few power generators in standby among 11-1 to 11-M. Thus, the operating rate of the power consumption bodies 2-1 to 2-N can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power control system comprising:
a plurality of power consumption bodies to which power is transmitted from a power system;
a power control equipment that controls activation of the power consumption bodies; and
a communication network that transmits and receives data between the power consumption bodies and the power control equipment,
wherein each power consumption body includes
a power meter that measures a power value to be transmitted to the power consumption body itself, and
a first communication interface that transmits and receives the data to and from the power control equipment via the communication network, and
wherein the power control equipment includes
a second communication interface that transmits and receives the data to and from the power consumption bodies via the communication network,
a power trajectory calculating unit that calculates a trajectory of the power value of the activated power consumption bodies, and
an activation control unit that controls the activation of the inactive power consumption body based on the trajectory of the power value.

2. The power control system according to claim 1, wherein the activation control unit makes the inactive power consumption body having an activation request remain standby when a trajectory of a sum of the power values tends to increase, and the activation control unit permits the activation of the inactive power consumption body having the activation request when the trajectory of the sum of the power values does not tend to increase.

3. The power control system according to claim 1, wherein the activation control unit makes the inactive power consumption body having an activation request remain standby when a trajectory of a sum of the power values tends to increase and the sum of the power values is equal to or more than a set value, and the activation control unit permits the activation of the inactive power consumption body having the activation request in other cases.

4. The power control system according to claim 1, further comprising power supplying utilities that supply power to the power system, wherein, the activation control unit, included in the power control equipment, further controls the activation of the inactive power supplying utilities, and based on the trajectory of the power value, the activation control unit controls the activation of the power supplying utilities supplying power to the power consumption body.

5. The power control system according to claim 4, wherein the activation control unit activates the inactive power supplying utilities when the trajectory of the sum of the power values tends to increase.

6. The power control system according to claim 1, further comprising:
a production managing tools that gives an instruction to activate the power consumption bodies in a predetermined process order via the communication network.

7. The power control system according to claim 6, wherein the power values of the activated power consumption bodies are measured by the power meters and are transmitted to the power control equipment via the communication network, then a sum of the power values of the power consumption bodies is chronologically recorded on power data storage.

8. The power control system according to claim 7,
wherein, when an activation request of the power consumption body is given through the production managing tool, the power trajectory calculating unit calculates a trajectory of a sum of the power values of the power consumption bodies and the activation control unit determines whether the trajectory of the sum of the power values of the power consumption bodies tends to increase at a time the activation request of the power consumption body is given, and
when the trajectory of the sum of the power values of the power consumption bodies tends to increase, the power consumption body having the activation request remains standby.

9. The power control system according to claim 8,
wherein, after a predetermined time since the power consumption body was given the activation request, it is redetermined whether the trajectory of the sum of the power values of the power consumption bodies tends to increase, and
when the trajectory of the sum of the power values of the power consumption bodies does not tend to increase, an instruction to activate the power consumption body is given through the production managing tool and the power consumption body previously given the activation request is activated.

10. The power control system according to claim 1, wherein the power values of the activated power consumption bodies are respectively measured by the power meters and are transmitted to the power control equipment via the communication network, then a sum of the power values of the power consumption bodies is chronologically recorded on power data storage.

11. The power control system according to claim 10,
wherein, when an activation request is given from the power consumption body, the power trajectory calculating unit calculates a trajectory of a sum of the power values of the power consumption bodies and the activation control unit determines whether the trajectory of the sum of the power values of the power consumption bodies tends to increase at a time the activation request of the power consumption body is given, and
when the trajectory of the sum of the power values of the power consumption bodies tends to increase, the power consumption body having the activation request remains standby.

12. The power control system according to claim 11,
wherein, after a predetermined time since the power consumption body gave the activation request, it is redetermined whether the trajectory of the sum of the power values of the power consumption body tends to increase, and
when the trajectory of the sum of the power values of the power consumption bodies does not tend to increase, an activation instruction is given to the power consumption body previously gave the activation request and the power consumption bodies are activated.

13. A power control equipment comprising:
a communication interface that acquires data regarding power values transmitted to activated power consumption bodies;
a power trajectory calculating unit that calculates trajectories of the power values of the activated power consumption bodies; and
an activation control unit that controls the activation of inactive power consumption bodies based on the trajectories of the power values.

14. The power control equipment according to claim 13, wherein the activation control unit makes activation of the inactive power consumption body having an activation request remain standby when a trajectory of a sum of the power values tends to increase, and the activation control unit permits the activation of the inactive power consumption body having the activation request when the trajectory of the sum of the power values does not tend to increase.

15. The power control equipment according to claim 13, wherein the activation control unit makes activation of the inactive power consumption body having an activation request to remain standby when a trajectory of a sum of the power values tends to increase and the sum of the power values is equal to or more than a set value, and the activation control unit permits the activation of the inactive power consumption body having the activation request in other cases.

16. The power control equipment according to claim 13, included in a power control system comprising power supplying utilities, wherein, the activation control unit further controls the activation of the inactive power supplying utilities, and based on the trajectory of the power value, the activation control unit controls the activation of the power supplying utilities supplying power to the power consumption body.

17. The power control equipment according to claim 16, wherein the activation control unit activates the inactive power supplying utilities when the trajectory of the sum of the power values tends to increase.

18. A power control method comprising:
acquiring data regarding power values transmitted to activated power consumption bodies from the power consumption bodies;
calculating trajectories of the power values of the activated power consumption bodies; and
controlling activation of inactive power consumption bodies based on the trajectories of the power values.

19. The power control method according to claim 18, wherein activation of the inactive power consumption body having an activation request remains standby when a trajectory of a sum of the power values tends to increase, and the activation of the inactive power consumption body having the activation request is permitted when the trajectory of the sum of the power values does not tend to increase.

20. The power control method according to claim 18, wherein activation of the inactive power consumption body having an activation request remains standby when a trajectory of a sum of the power values tends to increase and the sum of the power values is equal to or more than a set value, and the activation of the inactive power consumption body having the activation request is permitted in other cases.
